(19) United States
(12) Patent Application Publication
(10) Pub. No.: US 2013/0344348 A1
(43) Pub. Date: Dec. 26, 2013

(54) ZIRCONIUM ALLOY WITH COATING LAYER CONTAINING MIXED LAYER FORMED ON SURFACE, AND PREPARATION METHOD THEREOF

(71) Applicants: Yang-Hyun Koo, Daejeon (KR); Byoung-Kwon Choi, Daejeon (KR); Jeong-Yong Park, Daejeon (KR); Il Hyun Kim, Chungcheongnam-do (KR); Yang-Il Jung, Daejeon (KR); Dong Jun Park, Daejeon (KR); Hyun Gil Kim, Daejeon (KR)

(72) Inventors: Yang-Hyun Koo, Daejeon (KR); Byoung-Kwon Choi, Daejeon (KR); Jeong-Yong Park, Daejeon (KR); Il Hyun Kim, Chungcheongnam-do (KR); Yang-Il Jung, Daejeon (KR); Dong Jun Park, Daejeon (KR); Hyun Gil Kim, Daejeon (KR)

(73) Assignees: KOREA HYDRO AND NUCLEAR POWER CO., LTD., Gyeongsangbuk-do (KR); KOREA ATOMIC ENERGY RESEARCH INSTITUTE, Daejeon (KR)

(21) Appl. No.: 13/748,214

(22) Filed: Jan. 23, 2013

(30) Foreign Application Priority Data
Jun. 25, 2012 (KR) 10-2012-0067865

(51) Int. Cl. G21C 3/07; B32B 15/01; B05D 3/06

(52) U.S. Cl. CPC G21C 3/07; B05D 3/06; B32B 15/01
USPC 428/553; 376/416; 427/554; 428/472.2; 428/472; 428/469; 428/450; 428/332

(57) ABSTRACT

A zirconium alloy with a coating layer formed on a surface comprising a mixed layer, the mixed layer comprises one or more very high temperature oxidation resistant material and zirconium alloy parent material selected from the group consisting of Y₂O₃, SiO₂, ZrO₂, Cr₂O₃, Al₂O₃, Cr₃C₂, SiC, ZrC, ZrN, Si and Cr, and in a vertical direction on a boundary between the mixed layer and the zirconium alloy parent material is formed a gradient of compositions between the very high temperature oxidation resistance material and the zirconium alloy parent material.

### CROSS-REFERENCE TO RELATED APPLICATIONS

This application claims priority from Korean Patent Application No. 10-2012-0067865, filed on Jun. 25, 2012, in the Korean Intellectual Property Office, the disclosure of which is incorporated herein by reference in its entirety.

### BACKGROUND OF THE INVENTION

1. Field of the Invention

The present invention relates to a zirconium alloy with a coating layer including a mixed layer formed on surface, forming a gradient of compositions between very high temperature oxidation resistant material and a zirconium alloy parent material, and a preparation method thereof.

2. Description of the Related Art

Zirconium was rarely known before the end of 1940, but then gained popularity for utilization in the field of nuclear energy-related engineering material and nuclear material, thanks to its low neutron absorption cross section. The use of zirconium is particularly considered important in the material for the purpose of constructing spacer grid, guide tube, heavy water reactor compressing tube, or cladding tube for the fuel rod of the reactor, and alloy with uranium, for its advantages such as low neutral absorption cross section, high resistance to corrosion, and unique property that does not form radioactive isotopes.

Zr+2H₂O→ZrO₂+2H₂ Oxidation of zirconium

However, zirconium alloy component forms oxidized layer when radioactive dissociation of the water within the reactor by absorbing oxygen generated from the reaction between zirconium and water. As the thickness of the oxidized layer increases, the condition of the nuclear fuel assembly deteriorates. To overcome this shortcoming, the studies so far focused on increasing resistance to corrosion by increasing anti-oxidation property of the zirconium alloy. Because the above can lengthen lifespan of the reactor core structure, researches have mainly centered around the development of alloys.

However, it is increasingly considered important to keep the condition of a cladding tube under emergency situation such as accident has been increasingly.

As we learned from the Fukushima incident where the reactor had malfunctioning cooling due to natural disaster such as earthquake or tsunami, or man-made disaster, the cladding tube under impaired cooling function is exposed to high temperature, thus generating extreme amount of highly explosive hydrogen by very high corrosion rate. And when the hydrogen leaks into the reactor chamber, hydrogen detonates. The hydrogen detonation must be prevented, because this can lead into catastrophic incident accompanied with leakage of radioactive material.

Accordingly, the currently-available zirconium alloy material, which does not have particular concern under normal situation, is considered weak and unsafe when it comes to hydrogen generation and detonation under accident where the corrosion rapidly increases due to high temperature. However, if the nuclear fuel cladding tube maintains impaired resistance against high temperature oxidation even when exposed to the emergency condition, safety of the nuclear power plant will be significantly improved, considering the fact that sufficient time will be given to manage the risk of hydrogen generation under emergency situation.

The most widely used method of preparing zirconium alloy for use in cladding tube is to adjust the ratio of niobium (Nb), tin (Sn), iron (Fe), chromium (Cr) or oxygen (O). However, the improvement in the resistance against oxidation that can be obtained by utilizing alloying elements is limited, and this is particularly minute when considering the requirement for sustained anti-oxidation under very high temperature such as the emergency of the nuclear power plant. In other words, while the resistance against oxidation of the zirconium alloy rapidly decreases as the temperature rises, the way of minutely adjusting the alloying composition, as in the case of the currently-implemented approach, will hardly obtain the desired effect under high temperature corrosive environment. Accordingly, a technical improvement is necessary, to deal with the safety of nuclear fuel in emergency situation.

To overcome low resistance to oxidation of zirconium alloy in high temperature environment, the anti-oxidant material can be coated on the surface of the zirconium alloy and the stability of the nuclear fuel assembly can be increased. If anti-oxidant material stable under high temperature environment is coated to prevent oxidation from occurring on the surface of zirconium alloy due to sudden change in the environment and exposure to high temperature environment, oxidation will be greatly inhibited and the amount of generated hydrogen will be reduced, which in turn block risk factors such as hydrogen detonation, etc. However, not many anti-oxidant materials are available to inhibit oxidation under high temperature. Furthermore, it is a difficult challenge to ensure good adhesiveness between the zirconium alloy layer and the coated layer after the coating on the zirconium alloy, without causing physical damage under high temperature environment.

U.S. Pat. No. 5,171,520 and U.S. Pat. No. 5,268,946 disclose a technology to coat the ceramic and glass material with flame spraying to improve wear behavior of the cladding tube.

U.S. Pat. No. 5,227,129 discloses a method for coating zirconium nitrile (ZrN) with a cathodic arc plasma decomposition to improve anti-corrosiveness and wear behavior.

All the above-mentioned technologies aim to improve resistance to corrosion and wear-out of the nuclear fuel cladding tube in normal condition, and use coating materials of inter-metallic compounds (ZrN, ZrC) or ceramic (zircon) or glass (CaZnB, CaMgAl, NaBSi). However, it is hard to control the composition thereof, and due to wide physical difference between the coating layer and the parent material, physical damage (crack and blistering) frequently occur according to thermal expansion and deformation. In one example, ZrC (S. Shimada, Solid state ionics 141 (2001), 99-104) or ZrN (L. Krusin-Elbaum, M. Wittmer, Thin Solid Films, 107 (1983), 111-117) have been reported to fail to provide desired improvement of anti-corrosiveness in the event of accident at a nuclear power plant, because the layer turns to porous layer by the oxidation at high temperature.

The conventional studies on the coating on a nuclear fuel cladding aim to lift up the upper limit of the anti-corrosiveness by using alloying elements, by forming anticorrosive and anti-wear layer with ion implantation or Zr—N layer deposition on the surface of the cladding tube.

U.S. Pat. Nos. 4,279,667 and 2007 Materials and Design, 28 (4), 1177-1185 disclose a zirconium alloying structure and a processing technology thereof, using ion implantation to improve anti-corrosiveness.

KR 2006-0022768 disclose a technology of forming Zr(C, N) layer on the surface of cladding tube by chemical vapor deposition (CVD) or physical vapor deposition (PVD) to improve corrosiveness of the zirconium alloy cladding tube.

However, the above-mentioned technologies either provide new layers generated on the surface in an insufficient thickness to effectively prevent corrosion, or have columnar crystal structure and so is unable to prevent the oxidation due to diffusion of oxygen via grain boundary. Accordingly, a process is necessary, which generates a sufficient thickness of layer to hinder oxygen diffusion on the surface of tube for nuclear fuel cladding tube and prevents corrosion of the cladding tube.

The inventors of the present invention focused on a coating layer with a mixed layer formed on the surface in a gradient of compositions between very high temperature anti-corrosive material and zirconium alloy parent material, and confirmed that zirconium alloy having the coating layer on the surface thereof has a good anti-oxidant property under high temperature accident and thus can inhibit generation of hydrogen, that the mixed layer in the gradient of compositions can control physical damage such as crack or blistering between the coating layer and the zirconium alloy parent material, that it is possible to form the coating layer on the surface of zirconium alloy using a laser by controlling rotation of the laser head or stage by three axes and rotation, thereby enabling easy coating on not only sheets, but also tubes or frequently bent spacer grid, and that it is possible to easily adjust the thickness of the coating layer by controlling a supply of particles for coating and a laser heat source, and therefore, completed the present invention.

### SUMMARY OF THE INVENTION

An object of the present invention is to provide a zirconium alloy with a very high temperature anticorrosive coating layer which can inhibit physical damage such as crack or blistering.

Another object is to provide a method for forming a very high temperature anticorrosive coating layer on various forms of zirconium alloy such as sheets or tubes, or spacer grid, and forming a very high temperature anticorrosive layer on the surface of zirconium alloy according to which it is easy to control thickness of the coating layer.

To achieve the above-mentioned objects, in one embodiment, a zirconium alloy with a coating layer formed on a surface is provided, in which the coating layer may include a mixed layer, the mixed layer may include one or more very high temperature oxidation resistant material and zirconium alloy parent material selected from the group consisting of Y₂O₃, SiO₂, ZrO₂, Cr₂O₃, Al₂O₃, Cr₃C₂, SiC, ZrC, ZrN, Si and Cr, and a gradient of compositions between the very high temperature oxidation resistance material and the zirconium alloy parent material may be formed in a vertical direction on a boundary between the mixed layer and the zirconium alloy parent material.

In another embodiment, a method for preparing zirconium alloy with a coating layer comprising a mixed layer on a surface thereof, using a laser, is provided, which may include steps of: melting a surface of zirconium alloy parent material by irradiating a laser on the surface of the zirconium alloy parent material (step 1); preparing zirconium alloy with the coating layer including the mixed layer in which a gradient of compositions is formed between very high temperature oxidation resistant material and the zirconium alloy parent material, by supplying one or more very high temperature oxidation resistant materials selected from the group consisting of Y₂O₃, SiO₂, ZrO₂, Cr₂O₃, Al₂O₃, Cr₃C₂, SiC, ZrC, ZrN, Si and Cr on a site of melting on the surface of zirconium alloy parent material of step 1 (step 2); and cooling the zirconium alloy with the coating layer of step 2 formed (step 3).

The zirconium alloy having a coating layer formed on a surface thereof has a mixed layer formed in a gradient of compositions between very high temperature anticorrosive material and zirconium alloy parent material, to thereby provide excellent antioxidant property under high temperature accident as well as normal condition, and control physical damage such as crack or blistering between the coating layer and the zirconium alloy parent material due to the mixed layer formed in the gradient of compositions.

The preparation method of zirconium alloy having a coating layer with a mixed layer formed on the surface thereof can also control a laser head or stage by three axes and rotation, and therefore, it is possible to easily coat not only the sheets, but also tubes or frequently-bent spacer grid, and also to control thickness of the coating layer by manipulating the supply of the particles for coating and the laser heat source.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a conceptual view provided to compare a zirconium alloy with a coating layer containing a mixed layer forming a gradient of compositions between a very high temperature oxidation resistant material and a zirconium alloy parent material, and a zirconium alloy without the coating layer;

FIG. 2 is a view provided to explain a method for preparing a zirconium alloy with a coating layer containing a mixed layer using a laser, according to an embodiment of the present invention;

FIG. 3 presents optical microscopic (OM) images (FIG. 3a) and scanning emission microscopic (SEM) images (FIG. 3b) of a cross section of zirconium alloy of Example 1 with a coating layer including a mixed layer using very high temperature oxidation resistant material (Y₂O₃);

FIG. 4 presents optical microscopic (OM) images (FIG. 4a) and scanning emission microscopic (SEM) images (FIG. 4b) of a cross section of zirconium alloy of Example 2 with a coating layer including a mixed layer using very high temperature oxidation resistant material (SiC);

FIG. 5 presents optical microscopic (OM) images (FIG. 5a) and scanning emission microscopic (SEM) images (FIG. 5b) of a cross section of zirconium alloy of Example 3 with a coating layer including a mixed layer using very high temperature oxidation resistant material (Cr); and

FIG. 6 presents photographs of the surface of the zirconium alloy taken after the high temperature oxidation resistant test at 1000° C., 1000 sec., in which the zirconium alloy includes the coating layer including the mixed layer using Y₂O₃, SiC or Cr as very high temperature oxidation resistant material according to Examples 1 to 3 of the present invention.

### DETAILED DESCRIPTION OF THE INVENTION

The present invention will be explained in detail below.

In one embodiment, a zirconium alloy having a coating layer formed on a surface thereof is provided, in which the coating layer includes a mixed layer which includes one or more very high temperature oxidation resistant materials and zirconium alloy parent materials selected from the group consisting of Y₂O₃, SiO₂, ZrO₂, Cr₂O₃, Al₂O₃, Cr₃C₂, SiC, ZrC, ZrN, Si and Cr. The zirconium alloy includes a gradient of compositions between the very high temperature oxidation resistant materials and the zirconium alloy parent materials in a vertical direction on a boundary surface of the mixed layer and the zirconium alloy parent materials.

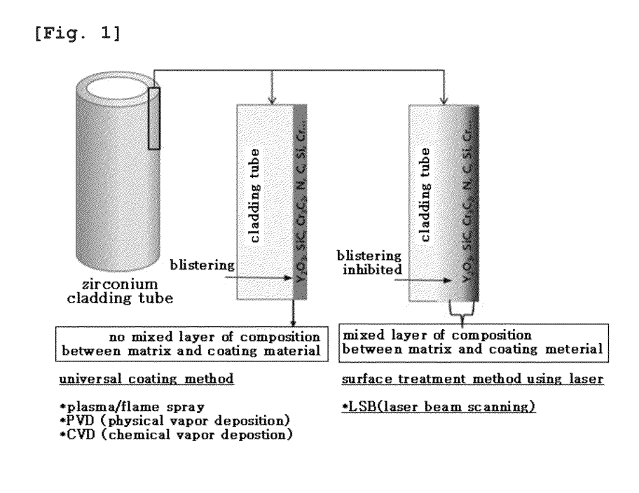

To be specific, in the zirconium alloy with a coating layer including a mixed layer formed on a surface thereof, the coating layer may additionally include a layer formed from one or more selected from the group consisting of Y₂O₃. SiO₂, ZrO₂, Cr₂O₃, Al₂O₃, Cr₃C₂, SiC, ZrC, ZrN, Si and Cr on an upper portion of the mixed layer (see FIG. 1).

Further, in the zirconium alloy with the coating layer including mixed layer formed on the surface thereof, the zirconium alloy parent material may use Zircaloy-4 (Zr—98.2 wt %, Sn—1.5 wt %, Fe—0.2 wt %, Cr—0.1 w %), Zircaloy-2 (Zr—98.25 w %, Sn—1.45 w %, Cr—0.10 w %, Fe—0.135 w % Fe, Ni—0.055 w %, Hf—0.01 w %), ZIRLO (Zr—97.9 wt %, Nb—1.0 wt %, Sn—1.0 wt %, Fe—0.1 wt %), M5 (Zr—99.0 w %, Nb—1.0 wt %) or HANA (High Performance Alloy for Nuclear Application, e.g., HANA-6; Zr—98.85 wt %, Nb—1.1 wt %, Cu—0.05 wt %), but not limited thereto.

The cladding tubes used for nuclear fuel in the currently-operating nuclear power plants are made from zirconium alloy, and more specifically, Zircaloy-4 and Zircaloy-2 are the alloys that are generally used as the nuclear fuel cladding tubes for commercial power plants. Further, ZIRLO, M5 and HANA with improved anti-corrosiveness have recently been developed and are preferable as the zirconium alloy parent materials in various embodiments of the present invention.

Furthermore, the very high temperature oxidation resistant material may use oxides including Y₂O₃, SiO₂, ZrO₂, Cr₂O₃, Al₂O₃, carbides such as Cr₃C₂, SiC, ZrC, nitrides such as ZrN, or pure metals such as Si, Cr singly or in combination. Since the above-mentioned materials have excellent anti-oxidant properties at high temperature, when the coating layer including the above-mentioned materials is formed on the surface of zirconium alloy, oxidation reaction of zirconium alloy is controlled not only under normal condition, but also when unexpectedly exposed to high temperature environment. Accordingly, generation of hydrogen is reduced, and the risk factor such as hydrogen detonation is prevented in the nuclear power plant. The properties of the very high temperature oxidation resistant material are tabulated below.

TABLE 1

| | | Phase Transform. | Melting Point | Thermal expansion | Thermal | Neutron Cross |
|---|---|---|---|---|---|---|
| Material | | Temp. (° C.) | (° C.) | Coff. (×10⁶K) | Conductivity (W/mK) | Section (barn) |
| OXIDE | Y₂O₃ | none | 2690 | 8.1 | 1.0 | 1.28(Y) |
| | | | | | | 0.0002(O) |
| | SiO₂ | Depends on | 1600 | 12.3 | 1.3 | 1.177(Si) |
| | | pressure | | | | 0.0002(O) |
| | ZrO₂ | M(970)/ | 2130 | 10.1 | 1.8-3.0 | 0.182(Zr) |
| | | T(1205)/Cubic | | | | 0.0002(O) |
| | Cr₂O₃ | none | 2400 | 9.0 | 2-5(coating) | 3.05(Cr) |
| | | | | | | 0.0002(O) |
| | Al₂O₃ | none | 2072 | 8.4 | 5-25(bulk) | 0.231(Al) |
| | | | | | | 0.0002(O) |
| CARBIDE | Cr₃C₂ | none | 1895 | 10.3 | 13 | 3.05(Cr) |
| | | | | | | 0.0035(C) |
| | SiC(CVD) | none | 2545 | <5 | 330 | 0.177(Si) |
| | | | | | | 0.0035(C) |
| | ZrC | none | 3540 | 7.01 | 12 | 0.185(Zr) |
| | | | | | | 0.0035(Cr) |
| NITRIDE | ZrN | none | 1960 | 7.24 | 10 | 0.185(Zr) |
| | | | | | | 1.9(N) |
| METAL | Cr | none | 1907 | 4.9 | 93.9 | 3.05(Cr) |
| | Si | none | 1414 | 2.6 | 149 | 0.177(Si) |
| PARENT MATERIAL | Zr | HCP(863)/8CC | 1850 | 7.2 | 10 | 0.185(Zr) |

The pure metal such as Si or Cr itself forms oxide such as SiO₂ or Cr₂O₃ and thus confers resistance to oxidation when oxidized at high temperature. Among the pure metals coated on the parent material, Si has the property of reducing hydrogen absorption and delaying transient that particularly increases corrosivity over time. Si also has antioxidant property from normal to high temperature, by forming SiO₂ when oxidized. Further, Cr is a transient metal which causes irregular growth orientation of zirconium oxide layer, but because this metal soon blocks oxide layer from growing in only one direction, abrupt breakage of the oxide layer is controlled. Like Si, Cr also forms oxide layer of Cr₂O₃ to thus carry anti-oxidant property from normal to high temperatures.

Further, the pure metals such as Si, Cr can control crack or blistering of the coating layer which may be generated due to plasticizing at high temperature which causes difference of heat expansion between the metal parent material and the coating material. Due to uniquely high heat conductivity of silver metal, the pure metal material such as Si or Cr ensures to meet the heat conductivity as required for the zirconium cladding tube for nuclear facilities.

Furthermore, the pure metals such as Si or Cr can provide even coating layer due to relatively lower melting point than those of oxides, carbides, or nitrides, and although there are some difficulties in controlling the exact composition ratio and crystal structure of the intermetal compounds, coating with the pure metals can overcome the above-mentioned drawbacks.

The thickness of the coating layer may preferably be adjusted to 3-500 μm, although not limited thereto, to improve anti-oxidant, anti-corrosive and adhesiveness of the parts. If the thickness of the coating layer is less than 3 μm, the coating layer is too thin to prevent the oxidization of the zirconium alloy at very high temperature. If the thickness of the coating layer exceeds 500 μm, mechanical condition that corresponds to the increased thickness cannot be expected and it is also disadvantageous economically.

Conventionally, as the coating on zirconium alloy surface is generally done by universal method such as plasma spraying, Physical Vapor Deposition (PVC), or Chemical Vapor Deposition (CVD), layer of mixed compositions do not appear between the coating material and the alloy parent material (see FIG. 1). As a result, coating layer has blistering due to difference in heat expansion rates as the temperature rises.

The present invention can solve the above-mentioned problem existing in the conventional art. That is, by forming a coating layer with a mixed layer containing a gradient of compositions between the very high temperature oxidation resistant material to be coated and zirconium alloy parent material, the interfacial separation is minimized, and the presence of the coating layer with the mixed layer containing the gradient of compositions between the very high temperature oxidation resistant material and the zirconium alloy parent material on the surface of zirconium alloy can minimize the interfacial separation between the coating layer and the zirconium alloy parent material.

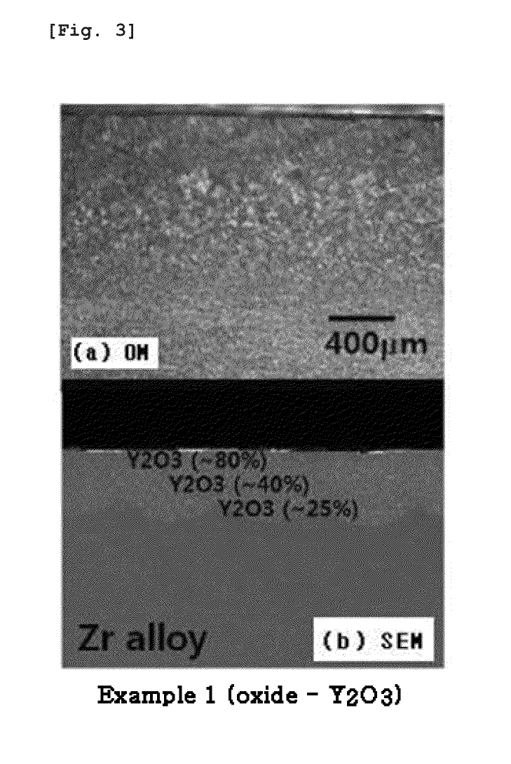

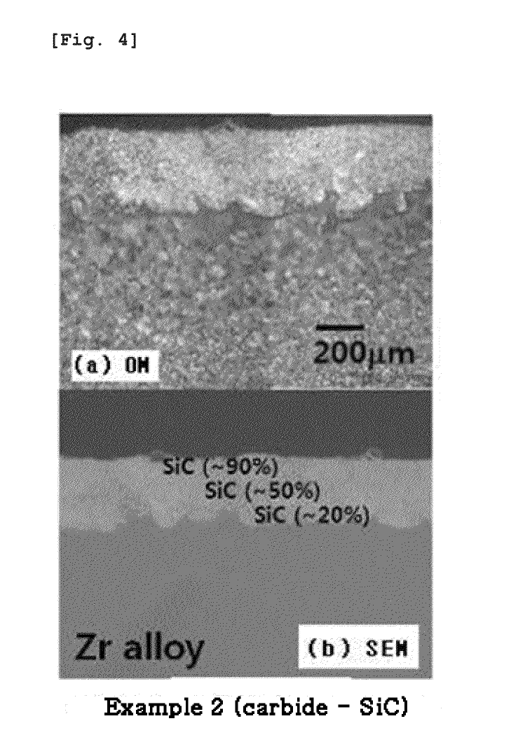

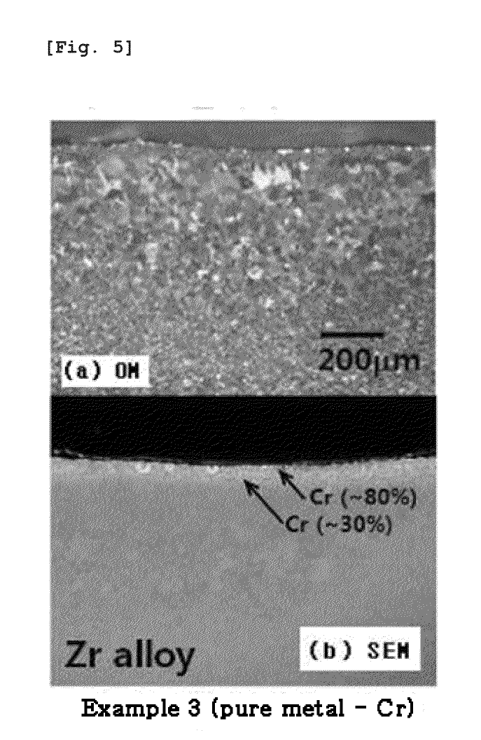

Referring to Experimental Example 1, observation on the cross section of zirconium alloy coated with very high temperature oxidation resistant material of Y₂O₃, SiC or Cr exhibited the result as illustrated in FIGS. 3-5, according to which a mixed layer of different materials with different particle sizes is formed. Accordingly, it can be concluded that a mixed layer, which includes different very high temperature oxidation resistant materials (e.g., Y₂O₃, SiC or Cr) of different particle sizes, is formed on the surface of the zirconium alloy.

Further, referring to Experimental Example 2, the composition of the surface of the zirconium alloy, coated with very high temperature oxidation resistant material of Y₂O₃, SiC or Cr, was analyzed, according to which it was revealed that while distances are different from the surface of zirconium alloy where the composition is analyzed, the contents of all the zirconium alloying materials increase as further away from the surface, with the increasing contents of the very high temperature oxidation resistant materials.

From the observations of Experimental Example 2, it was confirmed that, while the zirconium alloy with the coating layer including a mixed layer on the surface had different thickness of the mixed layer depending on the very high temperature oxidation resistant material as used, the mixed layer forms a gradient of compositions between the very high temperature oxidation resistant material and the zirconium alloy parent material, which has increasing contents of the very high temperature oxidation resistant material as further away from the boundary with the zirconium alloy parent material toward the surface of the mixed layer.

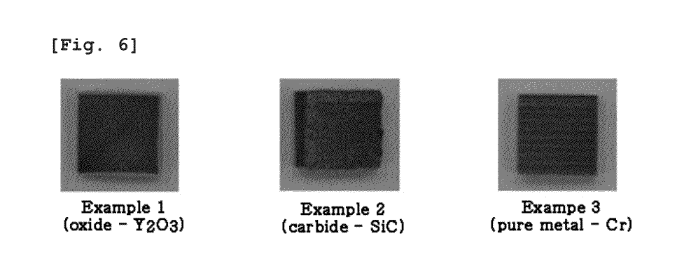

Furthermore, referring to Experimental Example 3, the test on the high temperature anti-oxidant property using very high temperature oxidation resistant materials of Y₂O₃, SiC or Cr revealed the result as illustrated in FIG. 6, according to which no blistering of the coating layer was observed due to heat expansion and oxidization during heating up to 1000° C. or cooling after oxidization test.

Further, referring to Experimental Example 3, as a result of measuring thickness of the oxide layer following 1000 sec oxidization test under very high temperature vapor environment with respect to the zirconium alloy coated with the very high temperature oxidation resistant materials of Y₂O₃, SiC or Cr, the thickness of the oxide layer of the zirconium alloy with the coating layer including the mixed layer according to the present invention was 15 μm, while the thickness of oxide layer of the zirconium alloy parent material without the coating layer was 31 μm or above.

From the above finding, it was confirmed that the zirconium alloy with the coating layer including the mixed layer according to the present invention provides improved anti-oxidant property at high temperature, and due to the presence of the mixed layer forming the gradient of compositions between very high temperature oxidation resistant material and zirconium alloy parent material, blistering of the coating layer from the heat expansion and oxidization reaction was not observed. Accordingly, zirconium alloy with the coating layer including the mixed layer according to the present invention can be advantageously used in the components of nuclear fuel assembly such as spacer grid, guide tube, heavy water reactor compression tube and cladding tube, which can be exposed to high temperature accident environment where the high temperature anti-oxidant property is required.

Furthermore, the present invention provides a nuclear fuel assembly component including zirconium alloy with a coating layer formed on the surface thereof.

To be specific, the nuclear fuel assembly component may include, for example, cladding tube, guide tube, measuring tube and spacer grid. The nuclear fuel assembly components are required to have high anti-oxidant property to prevent growth of oxide layer and mechanical deformation under high temperature and high pressure corrosive environment, and also to prevent explosion due to excessive generation of hydrogen at high temperature oxidation atmosphere such as in the accident situation where the temperature of the nuclear fuel rises. Accordingly, the zirconium alloy with the very high temperature oxidation resistant coating layer formed on the surface can be advantageously used in the nuclear fuel assembly components as explained above.

Further, the zirconium alloy according to the present invention is applicable to not only the nuclear fuel assembly components, but also the thermal power plant, aviation, metals or ceramic substances for military use, or others.

Furthermore, the present invention provides a method for preparing zirconium alloy with a coating layer including a mixed layer on a surface thereof, using a laser, in which the method may include steps of:

melting a surface of zirconium alloy parent material by irradiating a laser on the surface of the zirconium alloy parent material (step 1);

preparing zirconium alloy with the coating layer including the mixed layer in which a gradient of compositions is formed between very high temperature oxidation resistant material and the zirconium alloy parent material, by supplying one or more very high temperature oxidation resistant materials selected from the group consisting of Y₂O₃, SiO₂, ZrO₂, Cr₂O₃, Al₂O₃, Cr₃C₂, SiC, ZrC, ZrN, Si and Cr on a site of melting on the surface of zirconium alloy parent material of step 1 (step 2); and

cooling the zirconium alloy with the coating layer of step 2 formed (step 3).

Hereinbelow, the preparation method of zirconium alloy with a coating layer including a mixed layer formed on a surface using the laser will be explained in detail.

First, in the preparation method of zirconium alloy with the coating layer including the mixed layer formed on the surface using laser, step 1 relates to melting a surface of zirconium alloy parent material by irradiating a laser on the surface of the zirconium alloy parent material.

To be specific, the zirconium alloy parent material of step 1 may be Zircaloy-4, Zircaloy-2, ZIRLO, M5 or HANA, but not limited thereto.

Further, the irradiating the laser at step 1 may include positioning the zirconium alloy parent material on a movable stage and performing the irradiating while moving the movable stage, or fixing the zirconium alloy in position, and performing the irradiating while moving a laser irradiating portion.

Accordingly, because it is possible to control a laser head or stage by three axes and rotation, the preparation method of zirconium alloy with a coating layer including a mixed layer on the surface thereof using a laser can be implemented for use in not only sheets, but also 4 m tubes and frequently-bent spacer grids, thereby providing effect of easy processing, low cost and high efficiency of coating.

Furthermore, the site of melting at step 2 may be regulated to a predetermined depth by controlling a laser output. The conventional method including ion implantation, CVD, or PVD has shortcoming that the coating layer is not formed into sufficient thickness to effectively prevent corrosion. The present invention overcomes the above-mentioned drawback, because the coating layer is formed as the very high temperature oxidation resistant material is supplied to the site of melting. That is, because it is possible to easily adjust the thickness of the coating layer by manipulating a laser source (output), the drawback of insufficient thickness of the coating layer is resolved.

Further, the laser output may preferably range between 50-500 W. If the laser output exceeds 500, the parent material is damaged severely, degrading the property of the zirconium alloy for use in the nuclear fuel assembly component. If the laser output is below 50, homogenous mixture of the coating material and the parent material does not happen. Accordingly, the anti-oxidant effect of zirconium alloy due to coating layer is not likely. Furthermore, because the thickness of the mixed layer decreases, the effect of inhibited interfacial separation between the alloy parent material and the coating layer is also not likely.

Furthermore, the thickness of the coating layer including the mixed layer explained above may preferably be in the range of 3-500 μm, which may be adjusted by controlling the laser output or the supply of very high temperature oxidation resistant material.

Next, the preparation method of zirconium alloy with the coating layer including the mixed layer on the surface using a laser may include step 2 of preparing zirconium alloy with the coating layer including the mixed layer in which a gradient of compositions is formed between very high temperature oxidation resistant material and the zirconium alloy parent material, by supplying one or more very high temperature oxidation resistant materials selected from the group consisting of Y₂O₃, SiO₂, ZrO₂, Cr₂O₃, Al₂O₃, Cr₃C₂, SiC, ZrC, ZrN, Si and Cr on a site of melting on the surface of zirconium alloy parent material of step 1.

To be specific, the very high temperature oxidation resistant material at step 2 may be supplied along with a carrier gas. The carrier gas may not react with the very high temperature oxidation resistant material, and preferably be Ar or He.

Further, the very high temperature oxidation resistant material according to another embodiment may be supplied through a nozzle. The nozzle may be a cylindrical outlet which has a partially-reduced circular cross-section, and play a role of ejecting or spraying fluid with high speed.

Furthermore, the size of particles of the very high temperature oxidation resistant material supplied through the nozzle may preferably be 10-100 μm. If the particle size exceeds 10 μm, the particles are too large to be sprayed through an end of the injection nozzle. If the particle size is less than 100 μm, the air flow will be disturbed by the pressure to spray, and besides, the nozzle can be blocked.

Further, the nozzle to supply the very high temperature oxidation resistant material may be dual-tubular nozzle in which an interior may supply the very high temperature oxidation resistant material and the carrier gas and an exterior may supply inert gas.

The inert gas may use any gas provided that it can control oxidization by blocking the site of melting on the surface due to laser irradiation from the others, and may preferably be Ar or He.

Furthermore, the gradient of compositions between zirconium alloy parent material and the very high temperature oxidation resistant material according to the present invention may have increasing content of the very high temperature oxidation resistant material as farther from the boundary between the mixed layer and the zirconium alloy parent material toward the surface of the mixed layer.

Next, in the preparation method of zirconium alloy with the coating layer including the mixed layer using a laser according to the present invention, step 3 relates to cooling the zirconium alloy with the coating layer of step 2 formed thereon.

To be specific, if the zirconium alloy parent material is a sheet, the cooling at step 3 may be performed after positioning the zirconium alloy with the coating layer of step 2 formed thereon on a movable stage, with fluid between the movable stage and the sheet. The fluid for cooling may be lubricant for cooling purpose. For example, any type of grease with viscosity such as solid grease or liquid grease may be used.

Further, if the zirconium alloy parent material is a sheet, the cooling at step 3 may be performed after positioning the zirconium alloy with the coating layer of step 2 formed thereon on the movable stage, by passing fluid between the movable stage and the sheet. The fluid for cooling may use any material that can cool the melt portion of the matrix effectively. For example, lubricant for cooling purpose may be used singly or in combination. The lubricant for cooling purpose may use any type of grease with viscosity such as solid grease or liquid grease.

Furthermore, if the zirconium alloy parent material is a tube, the cooling at step 3 may be performed by passing fluid into the tube, with preferably positioning the zirconium alloy with the coating layer formed thereon on a stage having a rotatable axis so that the cooling is performed while rotatably conveying the alloy, and also adjusting cooling ability by adjusting the flowrate of the fluid.

Further, the present invention provides a preparation method of zirconium alloy with a coating layer including a mixed layer formed on a surface thereof using a laser, which may include steps of:

if a particle of one or more very high temperature oxidation resistant material selected from the group consisting of Y₂O₃, SiO₂, ZrO₂, Cr₂O₃, Al₂O₃, Cr₃C₂, SiC, ZrC, ZrN, Si and Cr is between 0.1-10 μm,

mixing the very high temperature oxidation resistant material with a solvent, and applying the same on a surface of zirconium alloy parent material (step 1);

preparing zirconium alloy with the coating layer including the mixed layer in which a gradient of compositions is formed between the very high temperature oxidation resistant material and the zirconium alloy parent material, by melting the applied very high temperature oxidation resistant material on the surface of the zirconium alloy with a laser irradiation (step 2); and

cooling the zirconium alloy with the coating layer of step 2 formed thereon.

The preparation method of the zirconium alloy with the coating layer including the mixed layer on the surface using a laser will be explained in detail below.

First, in a preparation method of zirconium alloy with a coating layer including a mixed layer formed on a surface thereof using a laser, if a particle of one or more very high temperature oxidation resistant material selected from the group consisting of Y₂O₃, SiO₂, ZrO₂, Cr₂O₃, Al₂O₃, Cr₃C₂, SiC, ZrC, ZrN, Si and Cr is between 0.1-10 μm, step 1 includes mixing the very high temperature oxidation resistant material with a solvent, and applying the same on a surface of zirconium alloy parent material.

To be specific, the solvent at step 1 may be any evaporable solvent that can efficiently dissolve the very high temperature oxidation resistant material, and may be used singly or in combination. The solvent may preferably be acetone, alcohol, or a mixture of acetone and alcohol, or more preferably, acetone or alcohol.

Further, the laser irradiation at step 2 and cooling at step 3 may be performed in the same manner as explained above with reference to the preparation method of zirconium alloy with a coating layer including a mixed layer on a surface using a laser, by first melting the surface of the zirconium alloy and supplying very high temperature oxidation resistant material.

Furthermore, the present invention provides zirconium alloy with a surface layer containing a mixed layer which is prepared by the method explained above using laser.

Certain examples and experimental examples of the present invention will be explained in detail below.

However, the examples and experimental examples are provided only for illustrative purpose, and therefore, should not be construed as limiting the present invention.

### Example 1

### Zirconium Alloy with Coating Layer Containing Mixed Layer Formed on Surface—1

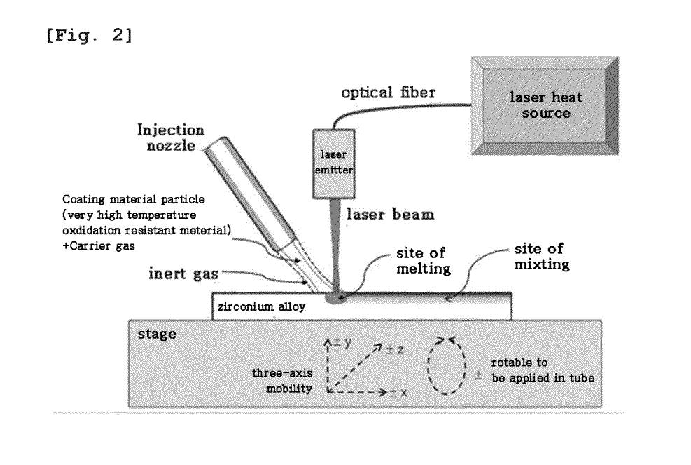

The zirconium alloy with a coating layer including a mixed layer on a surface was prepared using a laser with the device as illustrated in FIG. 2, in which the zirconium alloy parent material used Zircaloy-4 (Zr—98.2 wt %, Sn—1.5 wt %, Fe—0.2 wt %, Cr—0.1 w %), and the very high temperature oxidation resistant material used Y₂O₃. The laser output was set to 300 W, and the surface of zirconium alloy parent material was melted by irradiating laser on the surface of the Zircaloy-4 alloy parent material.

Next, the very high temperature oxidation resistant material, Y₂O₃, was injected along with the particle carrier gas Ar onto the site of melting on the surface of the zirconium alloy parent surface through an injection nozzle. The nozzle was a dual-tubular nozzle, in which an interior supplied the very high temperature oxidation resistant material Y₂O₃ and the carrier gas Ar, while an exterior supplied inert gas Ar. The inert gas plays the role of inhibiting oxidization at the site of melting on the surface of the alloy parent material due to laser irradiation.

If it is difficult to convey the very high temperature oxidation resistant material through the injection nozzle due to smaller grain size, the very high temperature oxidation resistant material can be supplied by way of mixing the very high temperature oxidation resistant material in a solvent such as acetone or alcohol and applying the same onto the surface of zirconium alloy parent material.

Next, the zirconium alloy with the coating layer formed thereon was positioned on a movable stage, and universally-used grease with viscosity was used as a lubricant for the purpose of cooling between the zirconium alloy and the stage, thereby leaving zirconium alloy with the coating layer including mixed layer of the very high temperature oxidation resistant material Y₂O₃ and the zirconium alloy parent material.

### Example 2

### Zirconium Alloy with Coating Layer Containing Mixed Layer Formed on Surface—2

The zirconium alloy with a coating layer including a mixed layer of SiC as the very high temperature oxidation resistant material and the zirconium alloy parent material was prepared by the same method as Example 1, except for using a carbide (SiC) as the very high temperature oxidation resistant material.

### Example 3

### Zirconium Alloy with Coating Layer Containing Mixed Layer Formed on Surface—3

The zirconium alloy with a coating layer including a mixed layer of Cr as the very high temperature oxidation resistant material and the zirconium alloy parent material was prepared by the same method as Example 1, except for using a pure metal (Cr) as the very high temperature oxidation resistant material.

### Comparative Examples 1-3

### Initial Parent Material of Zirconium Alloy

To investigate the high temperature anti-oxidant property of the zirconium alloy with a coating layer including a mixed layer on a surface according to the present invention by comparison, the coating layer of Examples 1 to 3 was formed on one surface of the sample prepared at Examples 1 to 3, and the coating layer was not formed on the other sides (Comparative Examples 1 to 3).

### Experimental Example 1

### Observation on Cross Section of Zirconium Alloy

The cross section of zirconium alloy with the coating layer including mixed layer on the surface as prepared by Examples 1 to 3 was observed under optical microscopy and scanning emission microscopy (SEM) and the result is provided by FIGS. 3 to 5.

Referring to FIGS. 3 to 5, a mixed layer of different materials of different particle sizes appeared, according to which it was confirmed that the zirconium alloy of Examples 1 to 3 had a mixed layer containing different types of very high temperature oxidation resistant materials (Y₂O₃, SiC or Cr) with different particle sizes on the surfaces thereof.

### Experimental Example 2

### Analysis on Gradient of Compositions of Mixed Layer

In the zirconium alloy with the coating layer including the mixed layer formed on surface according to the present invention, to investigate the formation of gradient of compositions by the mixed layer between very high temperature oxidation resistant material and zirconium alloy parent material, the composition by depth of the mixed layer was analyzed with respect to the zirconium alloy of Examples 1 to 3, and the result is tabulated into Table 2. The composition by depth of the mixed layer was analyzed using the Energy Dispersive Spectra (EDS) attached to the scanning emission microscope (SEM), and the area analyzed by the point analysis of EDS was 5 μm in diameter or less.

TABLE 2

| | Example 1 | | | Example 2 | | | Example 3 | | |
|---|---|---|---|---|---|---|---|---|---|
| Site of analysis | 3 | 150 | 300 | 3 | 80 | 160 | 3 | 20 | 40 |
| (distance from | | | | | | | | | |
| surface, μm) | | | | | | | | | |
| Analyzed | Y: 33 | Y: 16 | Y: 10 | Si: 47 | Si: 25 | Si: 10 | Cr: 92 | Cr: 46 | Cr: 17 |
| composition | O: 49 | O: 24 | O: 14 | C: 47 | C: 25 | C: 10 | Zr: 8 | Zr: 54 | Zr: 83 |
| (at. %) | Zr: 18 | Zr: 60 | Zr: 76 | Zr: 6 | Zr: 50 | Zr: 80 | | | |

As table 2 indicates, as the zirconium alloy of Example 1 was farther away from the surface, the content of zirconium alloy parent material increased by 18->60->76, while the content of the very high temperature oxidation resistant material (Y₂O₃) decreased by 82->40->34. Further, as the zirconium alloy of Example 2 was farther away from the surface, the content of zirconium alloy parent material increased by 6->50->80, while the content of the very high temperature oxidation resistant material (SiC) decreased by 94->50->20. Furthermore, as the zirconium alloy of Example 3 was farther away from the surface, the content of zirconium alloy parent material increased by 8->54->83, while the content of the very high temperature oxidation resistant material (Cr) decreased by 92->46->17. Considering that the distances from the surface where the compositions of Examples 1 to 3 varied, it was confirmed, it was confirmed that the thickness of the mixed layer formed on the zirconium alloy of Examples 1 to 3 were different from each other.

From the above finding, it was confirmed that while the zirconium alloy with a coating layer including a mixed layer on the surface according to the present invention has the mixed layer in varying thickness depending on the type of the very high temperature oxidation resistant material used, the mixed layer formed a gradient of compositions between the very high temperature oxidation resistant material and zirconium alloy parent material and that the gradient of compositions had increasing content of the very high temperature oxidation resistant material as farther away from the boundary surface of the zirconium alloy parent material toward the surface of the mixed layer.

### Experimental Example 3

### Test on High Temperature Anti-Oxidant Property

To investigate difference of anti-oxidant properties of the zirconium alloy with the coating layer including the mixed layer according to the present invention and the zirconium alloy without the coating layer, the following test was conducted on the zirconium alloy of Examples 1 to and Comparative Examples 1 to 3 and the result is provided by Table 3 and FIG. 6.

The zirconium alloy of Examples 1 to 3 and Comparative Examples 1 to 3 was cut into 10 nm segments and polished by SiC polishing paper. The polished segments were ultrasonic-cleaned in mixed solution of acetone and alcohol (50:50) and then dried. The dried segments were mounted on the test equipment for high temperature oxidation, and mixed gas of steam and argon was flowed at a flowrate of 10 ml per minute. Using reverberatory furnace attached to the equipment, the segments were heated by 0° C./sec, and maintained at very high temperature of 1000° C. for 1000 sec. After turning off the reverberatory furnace, Ar gas pressure was increased more than three-fold for cooling. The evaluation of oxidation resistance was based on the observation on the thickness of the oxide layer by SEM, with respect to the segments which were prepared to allow observation on the cross section of the oxidized segments at very high vapor temperature. The result is present in Table 3.

TABLE 3

| | Thickness of |
|---|---|
| | oxide |
| Category | layer (μm) |
| Example 1 | 15 |
| Example 2 | 8 |
| Example 3 | 6 |
| Comp. Ex. 1 | 32 |
| Comp. Ex. 2 | 31 |
| Comp. Ex. 3 | 33 |

Referring to FIG. 6, no blistering due to heat expansion and oxidation on the coating layer was observed, which was frequently observed during heating up to 1000° C. and cooling after the oxidation test.

Further, Table 3 lists the SEM result of measuring thickness of the oxide layer after conducting oxidation test under very high temperature vapor environment for 1000 sec, according to which the thickness of the oxide layer of the zirconium alloy with the coating layer including the mixed layer of Examples 1 to 3 was 15 μm, while the thickness of the oxide layer of the zirconium alloy of Comparative Examples 1 to 3 without the coating layer was 31 μm or above.

From the above finding, it was confirmed that the zirconium alloy with the coating layer including the mixed layer of Examples 1 to 3 had improved high temperature oxidation resistance, compared to the zirconium alloy of Comparative Examples 1 to 3 without the coating layer. Accordingly, the zirconium alloy with the coating layer including the mixed layer according to the present invention forming a gradient of compositions between the very high temperature oxidation resistant material and the zirconium alloy parent material, provides superior resistance to oxidation at very high temperature, and does not suffer blistering on the coating layer from the heat expansion and oxidation due to the presence of the mixed layer. Accordingly, the zirconium alloy according to the present invention can be advantageously used in the nuclear fuel assembly components including spacer grid, guide tube, heave water reactor compression tube and cladding tube, which can be exposed to high temperature accident.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended Claims.

1. A zirconium alloy with a coating layer formed on a surface, wherein
the coating layer comprises a mixed layer,
the mixed layer comprises one or more very high temperature oxidation resistant material and zirconium alloy parent material selected from the group consisting of Y₂O₃, SiO₂, ZrO₂, Cr₂O₃, Al₂O₃, Cr₃C₂, SiC, ZrC, ZrN, Si and Cr, and
in a vertical direction on a boundary between the mixed layer and the zirconium alloy parent material is formed a gradient of compositions between the very high temperature oxidation resistance material and the zirconium alloy parent material.

2. The zirconium alloy as set forth in claim 1, wherein the coating layer further comprises a layer on an upper portion of the mixed layer, which comprises one or more selected from the group consisting of Y₂O₃, SiO₂, ZrO₂, Cr₂O₃, Al₂O₃, Cr₃C₂, SiC, ZrC, ZrN, Si and Cr.

3. The zirconium alloy as set forth in claim 1, wherein the zirconium alloy parent material comprises one or more selected from the group consisting of Zircaloy-4, Zircaloy-2, ZILRO, M5 and HANA.

4. The zirconium alloy as set forth in claim 1, wherein the coating layer is 3-500 μm in thickness.

5. The zirconium alloy as set forth in claim 1, wherein the gradient of compositions between the very high temperature oxidation resistant material and the zirconium alloy parent material has increasing content of the very high temperature oxidation resistant material as farther away from a boundary between the mixed layer and the zirconium alloy parent material toward the surface of the mixed layer.

6. A nuclear fuel assembly component comprising the zirconium alloy with the coating layer comprising the mixed layer on the surface as set forth in claim 1.

7. The nuclear fuel assembly component as set forth in claim 6, wherein the nuclear fuel assembly component comprises one or more selected from the group consisting of a spacer grid, a guide tube, a heavy water reactor compression tube and a cladding tube.

8. A method for preparing zirconium alloy with a coating layer comprising a mixed layer on a surface thereof, using a laser, the method comprising steps of:
melting a surface of zirconium alloy parent material by irradiating a laser on the surface of the zirconium alloy parent material (step 1);
preparing zirconium alloy with the coating layer including the mixed layer in which a gradient of compositions is formed between very high temperature oxidation resistant material and the zirconium alloy parent material, by supplying one or more very high temperature oxidation resistant materials selected from the group consisting of Y₂O₃, SiO₂, ZrO₂, Cr₂O₃, Al₂O₃, Cr₃C₂, SiC, ZrC, ZrN, Si and Cr on a site of melting on the surface of zirconium alloy parent material of step 1 (step 2); and
cooling the zirconium alloy with the coating layer of step 2 formed (step 3).

9. The preparation method as set forth in claim 8, wherein the site of melting at step 2 may be adjusted in depth in accordance with adjustment of laser output.

10. The preparation method as set forth in claim 9, wherein the laser output may be 50-500 W.

11. The preparation method as set forth in claim 8, wherein the very high temperature oxidation resistant material at step 2 is supplied along with a carrier gas.

12. The preparation method as set forth in claim 11, wherein the carrier gas is Ar or He.

13. The preparation method as set forth in claim 8, wherein the very high temperature oxidation resistant material is supplied via a nozzle.

14. The preparation method as set forth in claim 13, wherein a particle size of the very high temperature oxidation resistant material is 10-100 μm.

15. The preparation method as set forth in claim 13, wherein the nozzle may be a dual-tubular nozzle comprising an interior which supplies the very high temperature oxidation resistant material and a carrier gas, and an exterior which supplies an inert gas.

16. The preparation method as set forth in claim 15, wherein the inert gas is Ar or He.

17. The preparation method as set forth in claim 15, wherein the inert gas inhibits oxidation by blocking the site of melting on the surface of the parent material from others.

18. A preparation method of zirconium alloy with a coating layer comprising a mixed layer formed on a surface thereof using a laser, comprising steps of:
if a particle of one or more very high temperature oxidation resistant material selected from the group consisting of Y₂O₃, SiO₂, ZrO₂, Cr₂O₃, Al₂O₃, Cr₃C₂, SiC, ZrC, ZrN, Si and Cr is between 0.1-10 μm,
mixing the very high temperature oxidation resistant material with a solvent, and applying the same on a surface of zirconium alloy parent material (step 1);
preparing zirconium alloy with the coating layer including the mixed layer in which a gradient of compositions is formed between the very high temperature oxidation resistant material and the zirconium alloy parent material, by melting the applied very high temperature oxidation resistant material on the surface of the zirconium alloy with a laser irradiation (step 2); and
cooling the zirconium alloy with the coating layer of step 2 formed thereon.

19. The preparation method as set forth in claim 18, wherein the solvent of step 1 is one or more selected from the group consisting of acetone, ethanol, and a mixed solution of acetone and alcohol.

20. The preparation method as set forth in claim 8, wherein the laser irradiation is performed after positioning the zirconium alloy on a movable stage, by moving the movable stage.

21. The preparation method as set forth in claim 8, wherein the laser irradiation is performed by moving a laser irradiating portion.

22. The preparation method as set forth in claim 8, wherein the gradient of compositions between the very high temperature oxidation resistant material and the zirconium alloy parent material has increasing content of the very high temperature oxidation resistant material as farther away from a boundary between the mixed layer and the zirconium alloy parent material toward the surface of the mixed layer.

23. The preparation method as set forth in claim 8, wherein, if the zirconium alloy parent material is a sheet, the cooling at step 3 may be performed after positioning the zirconium alloy with the coating layer of step 2 formed thereon on a movable stage, by passing fluid between the movable stage and the sheet.

24. The preparation method as set forth in claim 8, wherein, if the zirconium alloy parent material is a sheet, the cooling at step 3 may be performed by passing fluid through an interior of the sheet.

25. The preparation method as set forth in claim 18, wherein the laser irradiation is performed after positioning the zirconium alloy on a movable stage, by moving the movable stage.

26. The preparation method as set forth in claim 18, wherein the laser irradiation is performed by moving a laser irradiating portion.

27. The preparation method as set forth in claim 18, wherein the gradient of compositions between the very high temperature oxidation resistant material and the zirconium alloy parent material has increasing content of the very high temperature oxidation resistant material as farther away from a boundary between the mixed layer and the zirconium alloy parent material toward the surface of the mixed layer.

28. The preparation method as set forth in claim 18, wherein, if the zirconium alloy parent material is a sheet, the cooling at step 3 may be performed after positioning the zirconium alloy with the coating layer of step 2 formed thereon on a movable stage, by passing fluid between the movable stage and the sheet.

29. The preparation method as set forth in claim 18, wherein, if the zirconium alloy parent material is a sheet, the cooling at step 3 may be performed by passing fluid through an interior of the sheet.
